(19) United States
(12) Patent Application Publication
(10) Pub. No.: US 2010/0057832 A1
(43) Pub. Date: Mar. 4, 2010

(54) Requesting A Service

(75) Inventors: Stephen Tsun, Cupertino, CA (US); Jens U. Skakkebaek, San Carlos, CA (US); Brandon Pearcy, Cupertino, CA (US); Anurag Agarwal, Sunnyvale, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/200,697

(22) Filed: Aug. 28, 2008

(51) Int. Cl. G06F 15/16

(52) U.S. Cl. 709/203

(57) ABSTRACT

Among other disclosed subject matter, a computer-implemented method for requesting a service includes accessing a universal tag included in media content on a first device. The universal tag is configured for use in requesting content relating to any of a plurality of services for a portion of the media content. The method includes receiving service information for the media content, the service information indicating at least a first service of the plurality of services as being assigned to the portion. The method includes generating a request for the first service identified by the service information, the request generated using the universal tag.

### TECHNICAL FIELD

This document relates to information processing.

### BACKGROUND

Content can be published using various forms of media. For example, internet content such as web page graphical advertisements can target consumers with a specific lifestyle and demographic by selecting certain services to be displayed in certain locations within a publication. Publishers can use various systems such as software applications or other types of management tools to edit or control the layout and appearance of published content.

Publishers may wish to enhance their content by changing the layout of published content or the type of content published. Some approaches for identifying and managing locations of published content have been tried, for example combinations of software and hardware devices used to process information relating the type of content to the location in which the content is presented.

### SUMMARY

The invention relates to requesting a service.

In a first aspect, a computer-implemented method for requesting a service includes accessing a universal tag included in media content on a first device. The universal tag is configured for use in requesting content relating to any of a plurality of services for a portion of the media content. The method includes receiving service information for the media content, the service information indicating at least a first service of the plurality of services as being assigned to the portion. The method includes generating a request for the first service identified by the service information, the request generated using the universal tag.

Implementations can include any, all or none of the following features. The service information can be received from a second device that includes a registrar system configured to communicate any of a plurality of portions of service information to a plurality of first devices, the registrar system configured for assigning the universal tag to another one of the plurality of services without modifying the media content. The media content can include a page and the plurality of services are page-level services, and the universal tag can be configured for use in requesting content for a plurality of slots on the page, and the request can be a single request applying to the plurality of slots. The page can be generated by a publisher associated with an account identifier that is included in the universal tag, and the method can further include registering information about which of the plurality of services the publisher uses; and using the information in at least one of generating the request and responding to the request.

The first service can include serving an advertisement to the page, and the universal tag in addition can be configured to request content for the page from a second service, and the method can further include receiving version information with the advertisement, the version information indicating that the second service has been updated to a new version; and generating a request for updated service information, the request indicating that the updated service information is to cover the new version. At least the first service can be requested using a script portion, and the method can further include receiving the script portion from a third device in connection with requesting the page; and storing the script portion in a memory on the first device; wherein when the page is generated the script portion can be obtained from one of the third device and the memory depending on whether the script portion has previously been stored.

The first service can be defined as a default service among the plurality of services, and the service information: can indicate that the first service is assigned to the portion by not explicitly mentioning the first service; and, for any other slot on the page assigned to a second service that is not the default service, can indicate the assignment to the second service by explicitly mentioning the second service. The method can further include detecting that a publisher of the page uses the first service most frequently; and assigning the first service to be the default service based on the detection. The method can further include generating a request for the service information, wherein the service information when received further identifies at least one parameter to be used in the first service; and using the parameter in requesting the first service. The method can further include changing the assignment of the first service to the universal tag without modifying the media content. Changing the assignment can include removing the assignment of the first service and instead assigning a second service to the universal tag, the second service provided from a third device, wherein the assignment of the second service may not involve a modification at the third device.

The method can further include receiving identification of at least one parameter with the service information; generating script for requesting the first service; and using the script in generating the request for the first service. A parameter may not be delivered with the service information, and the method can further include deriving at least one parameter based on a marker associated with the universal tag. The service information can be subject to versioning based on service enhancements, and the method can further include, in connection with a first time the media content is provided to the first device, storing on the first device a first version number regarding the assignment of the first service to the universal tag; forwarding the first version number when another request is generated; and using the stored first version number in requesting the service information, until an instruction is received, in response to forwarding the first version number, that the first version number has been updated to a second version number.

The service information can further indicate a second service of the plurality of services as being assigned to another portion of the media content, and the method can further include receiving additional service information having a higher priority than the service information, the additional service information indicating that the second service is not to be requested for the other portion; wherein the second service may not be requested for the other portion based on receiving the additional service information. The media content can include a page, at least some of the plurality of services can be page-level services, and the service information can be subject to versioning based on service enhancements, and the method can further include storing at the first device a current version number of the assignment of the first service to the portion of the page, and a last update time of the assignment; updating the last update time based on the assignment being modified; using the current version number if the last update time does not meet an expiration criterion; and requesting a new version number if the last update time meets an expiration criterion.

The method can further include determining a number of portions of the media content, including the portion assigned to the first service, that are assigned to any of the plurality of services; comparing the determined number with the service information, which is stored in a non-cookie storage on the first device; and updating the service information if the comparison shows that the service information does not match the determined number.

In a second aspect, a system includes a first device accessible to a user. The first device is configured to access a universal tag included in media content and configured for use in requesting content relating to any of a plurality of services for a portion of the media content. The system includes a registrar system configured to provide service information for the media content to the first vice, the service information indicating at least a first service of the plurality of services as being assigned to the portion. The system includes a server device configured to provide the first service to the first device in response to a request generated using the universal tag.

Implementations can include any, all or none of the following features. The media content can include a page having a plurality of slots, and the first service can include providing an advertisement for the page. The first device can be configured to store script for requesting the content in a memory on the first device, and the first device can obtain the scrip using the universal tag and generates the request using the script.

In a third aspect, a computer-implemented method for requesting a service includes accessing a tag included in media content on a first device, the tag configured for use in calling a service description for each of at least two portions of the media content. The method includes receiving the service description for the media content, the service description indicating at least a first service of the plurality of services as being assigned to the portion. The method includes generating a request for the first service identified by the service description, the request generated using the tag.

In a fourth aspect, a computer-implemented method for indicating a service includes receiving an identifier associated with first media content, the identifier obtained from a tag included in the first media content, the tag configured for use in requesting second media content relating to any of a plurality of services. The method includes accessing an assignment record using the identifier, the assignment record including assignments relating to the plurality of services. The method includes forwarding service information for the first media content, the service information indicating at least a first service of the plurality of services to be used in obtaining the second media content.

Implementations can include any, all or none of the following features. The first media content can be a page to be displayed on a computer device, and the service information can be provided from a registrar system configured to provide indications regarding the plurality of services to a plurality of pages. The first service can be defined as a default service among the plurality of services, and the service information: can indicate that the first service is to be used in obtaining the second media content by not explicitly mentioning the first service; and, for any other slot on the page assigned to a second service that is not the default service, can indicate the assignment to the second service by explicitly mentioning the second service.

Implementations can provide any, all or none of the following advantages. A universal tag can be provided that flexibly works with any of multiple services. Administration of content distribution can be improved. Service assignment can be modified, for example using a registrar, without having to edit a publisher's page where the modified service is to be requested, or a server that provides the service. Publishers can reconfigure the sources of one or more services, for example using one or more server devices. Service version information can transparently be updated by one or more server devices.

The details of one or more embodiments are set forth in the accompanying drawings and the description below. Other features and advantages will be apparent from the description and drawings, and from the claims.

### DESCRIPTION OF DRAWINGS

FIG. 1 is a block diagram of a system that can be used for delivering content such as publisher's pages.

FIG. 2 shows an example code segment for implementing a universal tag.

FIG. 3 shows an example sequence for configuring and presenting advertising information.

FIG. 4 is a block diagram of a computing system that can be used in connection with computer-implemented methods described in this document.

Like reference symbols in the various drawings indicate like elements.

### DETAILED DESCRIPTION

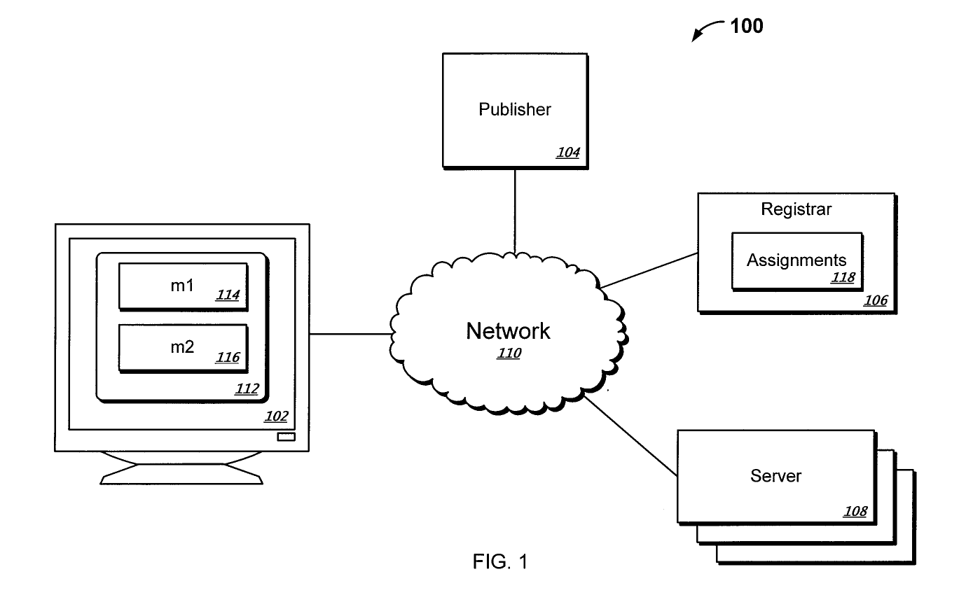

FIG. 1 is a block diagram of a system 100 that can be used for delivering content such as publisher's pages. The system 100 includes at least one device 102 for viewing content, a publisher system 104 for managing publishing content, a registrar system 106 for managing the mapping of service information and one or more server devices 108 for providing services such as sourcing content. These components of the system 100 can communicate through a computer network 110. The computer network 110 can be the Internet, an internal LAN, or any other computer network. In some implementations, other configurations can be used, including some that do not have a client-server architecture.

In some implementations, the device 102 can include a display for presenting software applications such as web browsers. In some implementations the device 102 can be a computing device such as a desktop computer, a mobile phone, an internet terminal or any other computing device. In other implementations, the device 102 can be a non-computing device such as a television or a digital billboard. Any device with capabilities for viewing content can be included in the system 100. For example, the device 102 can be a desktop computer configured with a web browsing software application for viewing web pages such as an illustrated web page 112.

The web page 112 is a resource of information that can be accessed through an application such as a web browser. In some implementations, a web page may be retrieved from a local computer or from a remote server, such as the server device 108. For example, web pages can include content such as advertisements, videos, flash animations, and other content sourced from one or more server devices 108. In some implementations, some or all of the content to be included in web pages can be requested using a tag. Tags can be used to reference, describe, link or point to other content. Tags can include a keyword or piece of information included in the source code of a page that can reference other content.

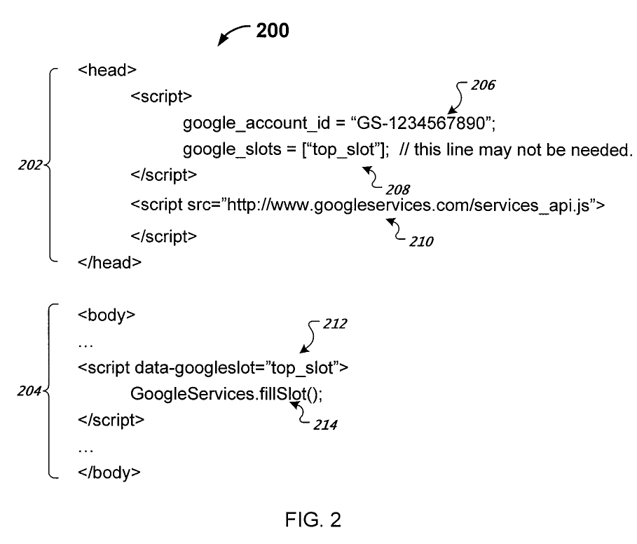

The publisher system 104 can be configured to manage content for publication. In some implementations, the content managed by the publisher can be published as a web page 112 viewable on the device 102. The publisher can provide for one or more content portions such as advertisements to appear on the page(s) when published. For example, an advertising management system or web publishing tool can work in cooperation with an account identifier associated with the publisher that is included in the publisher's page or other content. In some implementations, a tag included in the publisher's page can be used by the registrar system 106 to identify relevant configuration information for the page and forward that information for use in presenting the page. Example details and functionality of the published content are described later for FIG. 2.

In some implementations, the registrar system 106 can be configured as a physical server, a software application running on another server or combinations thereof. The registrar system 106 can be configured to manage a publisher's content placement information. The content placement information can include the mapping of services to web page marker information. In some implementations, the example web page 112 can include one or more markers displayed at any location within the web page 112. Markers (e.g., here labeled 114 and 116) can be configured to display one or more types of services. Services can refer to displaying content in a marker's location within a web page 112 or any other type of action being performed. For example, a service can include advertising, gadgets, widgets, video, text, maps and/or any other content. In some implementations, services can be managed by and sourced from the one or more server devices 108.

In some implementations, the web page 112 can include one or more markers that are not presented with the content of the page 112. For example, a marker can be assigned a service that tracks page views of a page 112. In this example, the tracking service can communicate information to another service or device rather than presenting information with the page 112.

Referring to web pages 112 that include advertising, the markers 114 and 116 can be configured as advertisements that can be arranged anywhere on the web page 112. For example, advertisements can be arranged near the top, sides or bottom of the page. In some implementations, advertisements can be included within other content that has been inserted into a web page. In some implementations, the markers 114 and 116 can be arranged in a priority fashion. For example, the marker 114 may receive content before the marker 116 or marker 114 may receive exclusive content more often than marker 116. This priority may be managed by the publisher system 104.

In some implementations, markers can include one or more size specifications used by a browser, such as a web browser, to allocate space on the page 112 for the marker to be presented. For example, an advertisement service to placed in marker ml can be presented in the marker ml with size specifications of 200 pixels in width and 100 pixels in height. In some implementations, services may be provided to markers if the sizing constraints allow the service to be displayed. For example, if marker ml has a limited area in which to be displayed, a service such as a large graphical advertisement may be too large for the marker m1. In this example, the service may be unavailable to the first marker 114.

The mappings of markers and their respective services can be managed and stored as assignments 118 in the registrar system 106. The assignments 118 can relate marker information to services within the registrar system 106. In some implementations, the assignments 118 for a publisher system 104 can include machine-readable data structure(s) relating a marker on a page 112 with a service represented by the marker. In some implementations, managing the assignments 118 using the registrar system 106 can allow a publisher to change the assignment of various services to their respective markers without accessing or affecting either the content of the page 112 or the one or more server devices 108 from which the services are sourced. For example, the publisher 104 can access the registrar 106 to change the service assigned to the first marker 114. By modifying the assignment 118 for the marker 114, the service presented for the first marker 114 can be changed without accessing the assigned service stored on the one or more server devices 108 and without accessing the content of the page 112 that includes the marker 114.

One or more of the server devices 108 can be configured to manage content displayable in the web pages 112. In some implementations, the one or more server devices 108 can be load-balanced to ease the processing burden on any one particular server device 108. In other implementations, multiple server devices 108 can each be configured to provide certain types of content for certain web pages 112.

In some implementations, markers can be configured to represent service(s) functioning at a page level with regard to the web pages 112. In some implementations, page level services can refer to managing service information using the “services_api.js” script described as an exemplary script included in the generic domain 210 for FIG. 2. For example, a service can be assigned to a group of pages, such as the pages in the “sports” area of a web site. In some implementations, assigning services to markers at the page level can include “roadblocking”. Roadblocking can refer to a publisher's content taking over most or all of the available markers on content, such as web page. For example, advertisements from a single publisher can be configured for presentation in the markers m1 and m2 where these markers are the only available markers on the page 112. In some implementations, page level services can reduce the communication burden normally required for communicating services for each marker.

In the exemplary illustration FIG. 1, the first marker ml is configured for an advertising service such as Google™ AdSense. The second marker m2 can be configured for a map service such as the maps provided by Google™ Maps. Rendering the web page 112 that includes the markers (e.g.; 114 and 116) can involve communicating a request through the network 110 to the registrar system 106 to obtain identities of the respective services assigned to the markers m1 and m2. The response from the registrar system 106 can include information for matching markers with their respective services. The response from the registrar system 106 can further include any parameters belonging to the respective services. For example, a map service can include parameters for the preferred sizing of the map or for the appearance of the map

FIG. 2 shows an example code segment 200 for implementing a universal tag. In this example, the segment 200 includes a “head” portion 202 and a “body” portion 204 of a web page source code. Other portions of web page source code can be included in the code segment 200. The source code of a web page can be programmed in any of various languages and can include combinations of those languages. In some implementations, the source code of a web page can be a compilation of multiple source code files programmed or written in multiple languages.

The source code of a web page can include one or more commonly used tags. The example code segment 200 shows computer programming code written in the Hypertext Markup Language (HTML) and the Javascript scripting language. Other types of markup languages and scripting languages can be included in the code segment 200. The source code for the page 112 (e.g., a web page), can be interpreted by a device 102 (e.g., a web browsing device). In some implementations, some or all of the code segment 200 can be interpreted or compiled into another code segment before being communicated from a server device 108 through a network 110 to a device 102.

The <head> HTML tag generally starts the <head> portion at the top of the web page. This <head> tag is commonly inserted at or near the top of web page source code and comes before the <body> tag according to HTML standards (e.g.; HTML 4.0 specification from the Worldwide Web Consortium (W3C)). The <head> portion of an HTML web page can end with an html </head> tag. Other information and tags can be included within the <head> portion of a code segment. One example of information that can be included within the <head> portion of a code segment includes the title of a web page (e.g.; text enclosed by the tags <title> and </title>). In some implementations, the portion 202 can include client-side script (e.g.; the text content enclosed by the tags <script> and </script>) written in various languages such as javascript and/or vbscript that can execute calls to a server/registrar. Many types of scripting languages can be used.

The <body> HTML tag generally starts the portion of a web page that defines the page's body. The <body> portion of the segment 200 can contain the contents of the document such as text, images, colors, and graphics. The <body> portion of an HTML web page can end with an html </body> tag. Other information and tags can be included within the <body> portion of a code segment.

In some implementations, the code segment 200 can include script that communicates a request to retrieve information from a server device 108. For example, the information can be a record of names stored in a database to be included in a page 112. In this example, the script included in the code segment 200 can trigger a process on the server device 108 to retrieve the record of names and communicate to the device 102 an updated code segment 200. In some implementations, the updated code segment 200 can be interpreted by a browser (e.g., a web browser) on the device 102.

In some implementations, the head portion 202 of the code segment 200 can include an account identifier 206, a marker parameter 208 and a generic domain 210. In some implementations, the marker parameter 208 can be optional. The portion 202 can include other content including parameters, scripts, code segments and other information. In some implementations, the identifier 206, the parameter 208 and the generic domain 210 can be included in portions of the code segment 200 other than within the <head> portion. For example, the identifier 206, the parameter 208 and the generic domain 210 can be included in portions of the code segment 200 before the <head> portion, after the <head> portion, within the <body> portion or any other portion of the code segment 200.

In some implementations, the account identifier 206 can refer to an account for a publisher, such as a publisher using the publisher system 104. The account identifier 206 can be used to search for information related to the specific publisher, the information located on the registrar system 106 and/or the one or more servers 108.

In some implementations, the marker parameter 208 can relate to content to be included in a page. For example, the marker parameter 208 can correspond to the location of an advertisement (e.g., “top_slot”). In some implementations, the one or more parameters 208 can be configured by another application, such as a user interface for describing names for advertisements. For example, the publisher system 104 can include a user interface for generating names for advertisements, placing the names as parameters in the code segment 200, and providing a mechanism for copying the generated code segment 200 or portions thereof into a page 112. In some implementations, the marker parameter 208 can be accessed by the generic domain 210. For example, the generic domain 210 can access a service that processes general requests from web pages to retrieve advertising configurations. The generic domain 210 can include various scripts that can be named in various ways. For example, the illustrated generic domain 210 for FIG. 2 can be named “google_services.js”. In another example, this script included in the generic domain 210 can be named “services_api.js” or any other name. The parameter 208 can be provided to the generic domain 210 for retrieving the advertising information associated with the parameter 208.

In some implementations, the parameter 206, the parameter 208 and other parameters can be defined before or after they are accessed within the <head> portion 202 by other parameters or functions. For example, a separate code segment stored in a separate file can define and initialize the parameter 206 and the parameter 208 before it is accessed by the <head> portion 202.

The <body> portion 204 of the code segment 200 can include a script parameter 212 and a function call 214. In some implementations, the script parameter 212 can be generated by a user. For example, the publisher system 104 can include a user interface where a user can create or select one or more parameters by name. In some implementations, the parameter 212 and other parameters can be defined before or after they are accessed within the <body> portion 204 by other parameters or functions. For example, a separate code segment stored in a separate file can define and initialize the parameter 212 before it is accessed by the <body> portion 204.

In some implementations, the function call 214 can communicate a request for information, such as from a temporary storage. For example, the function call 214 can request configuration information, such as script, from a browser cache. An example browser cache is described below.

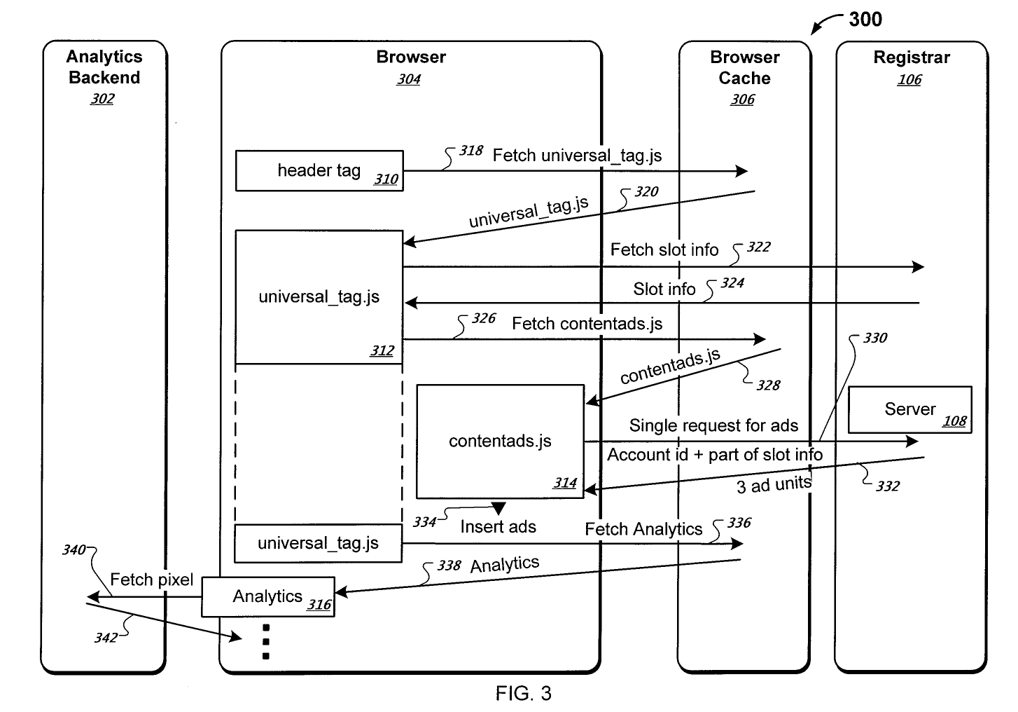

FIG. 3 shows an example sequence 300 for configuring and presenting advertising information. In some implementations, configuring advertising information can include gathering data on how the advertisements can be displayed. In one example, certain advertisements can have higher or lower priority relative to other advertisements. In another example, advertisements may have certain display size constraints and as such, may be presented in areas of display area where space is available. In some implementations, presenting advertising information can include receiving the configuration information for one or more advertisements and displaying the advertisements to a user. In some implementations, the system 300 can include an analytics backend 302, a browser 304, a browser cache 306, the registrar system 106 (FIG. 1) and the server device 108 (FIG. 1). For example, the browser 304 and the browser cache 306 can be located in the device 102.

In some implementations, the analytics backend 302 can include a system that gathers information about activity. For example, in the context of advertising, the analytics backend 302 can be a system that tracks statistical information including how many times an advertisement is viewed by a user of the browser 304 and/or whether the user interacts with the advertisement, to name just a few examples.

In some implementations, the browser 304 can be a software application such as a web browser that enables a user to display and interact with text, images, videos, music and other information typically located on a web page at a website on the world wide web or a local area network. Some examples of web browsers include Mozilla Firefox, Safari, Konqueror, Opera, Flock, Internet Explorer, Epiphany, K-Meleon and AOL Explorer. Browsers can be used to access the World Wide Web, and also be used to access information provided by web servers in private networks or content in file systems.

In some implementations, the browser 304 can interpret web pages such as the web page 112 described previously for FIG. 1. By way of example, the browser 304 can interpret script and tag information such as a header tag 310, a universal_tag.js script 312, a contentads.js script 314 and an analytics script 316.

Referring again briefly to the code segment 202 (FIG. 2), in some implementations the header tag 310 can refer to one or more tags included in the head portion 202 of the code segment 200. For example, the header tag 310 can include an account identifier 206 that maps or refers to a publisher identifier and can be used for fetching the configuration for the specific page

The universal_tag.js 312 can refer to script to be interpreted by the browser 304. In some implementations, the script 312 can include information or content received from the browser cache 306 and/or the registrar 106. For example, the information received can include configuration information for placing advertisements in a page. For instance, advertisement information can include script that retrieves the assignments of available advertising spaces (e.g., markers such as the markers 114 and 116) with services to be displayed in those spaces. Referring to FIG. 2, in some implementations, the script 312 can be a script included in the generic domain 210 such as “services_api.js” or a generic domain script “google_services.js”.

The contentads.js 314 can refer to script interpreted by the browser 304 that retrieves content (such as ads, etc.) and prepares it for rendering by the browser 304. In some implementations, the script 314 can communicate a request for information from the server 108 and/or the registrar 106. For example, the communication can include a single request for advertising content. In some implementations, the communication can include an account identified for a certain publisher and advertisement marker information for the web page being interpreted by the browser 304.

The analytics 316 can refer to programming script that gathers and supplies data to the analytics backend 302. The analytics 316 is accessible to the browser 304. In some implementations, the analytics 316 can include statistical information for a page. For example, the analytics 316 can include a count of how many times certain content is viewed in a page displayed by the browser 304. In another example, the analytics 316 can include a count of how many times a certain advertisement is “clicked” on from a page displayed by the browser 304.

The browser cache 306 can store copies of information passing through it. In some implementations, the browser cache 306 can reduce bandwidth usage, load on the servers and perceived wait time for a user. In some implementations, the browser cache 306 can be accessed as subsequent requests for stored information are received. For example, the universal_tag.js script 312, the contentads.js script 314 and/or the analytics script 316 can be cached and used more than once by the browser 304.

The registrar system 106 can be configured to manage a publisher's content placement information. Examples of the registrar system 106 were described above with regard to FIG. 1. The one or more server devices 108 can be configured to manage content displayable in the web pages 112. Examples of the server devices 108 were described above with regard to FIG. 1.

By way of example, the browser 304 fetches script from the browser cache 306. This fetch request can be referred to as “fetch universal_tag.js” and is here illustrated as step 318. In response, the browser cache 306 can send the script (e.g., the javascript “universal_tag.js”) to the browser 304, illustrated as step 320.

In some implementations, the browser 304 can fetch information from the registrar 106. In other implementations, the browser 304 can fetch information from the one or more servers 108. This fetch request can be referred to as “fetch slot info” and is here illustrated as step 322. In response, the registrar 106 can send the information (e.g., the slot information) to the browser 304, illustrated as step 324. The browser 304 can execute the universal_tag.js 312 script. The script 312 can use the information retrieved from the registrar system 106.

The browser 304 can fetch script from the browser cache 306. This fetch request can be referred to as “fetch contentads.js” and is here illustrated as step 326. In response, the browser cache 306 can send the script (e.g., the javascript “contentads.js”) to the browser 304, illustrated as step 328.

The browser 304 can send a communication to the one or more server devices 108 for one or more services to be performed. In some implementations, this request can include a request for advertisement information. In some implementations, the request can include a single request for multiple advertisements to be placed in a plurality of slots, illustrated as step 330. The request communicated at step 330 can include parameters. For example this single request can include identification information (e.g., the account identifier 206, FIG. 2) that relates a publisher and the publisher's respective content configuration information for the advertisements available for the publisher. In response, the registrar 106 can send multiple advertisements to the browser 304, illustrated as step 332. In some implementations, the content received from the server device 108 (e.g., advertisements) can be included in the page interpreted by the browser 304, illustrated as step 334.

The browser can send a communication to the browser cache 336 for information. In some implementations, the communication 336 can be sent to another server device instead of the browser cache 306. For example, the first time the communication 336 is sent, information may not be available in the cache 306. In this example, another server or backend system can provide the response to a service, such as the analytics service 316. In some implementations, the request can include a request for statistical code. For example, statistical code can refer to the programming code that forms the analytics 316. In response, the browser cache 306 can send the statistical (e.g., analytics) code to the browser 304, illustrated as step 338.

The analytics 316 can determine statistical information and communicate it to the analytics backend 302. In some implementations, this communication can be referred to as “fetch pixel” and is illustrated as step 340. In other implementations, the communication can include one or more requests. In response, the analytics backend 302 can send a communication to a user interface for viewing analytics information, illustrated as step 342. In some implementations, the communication sent at step 342 can include statistical information such as accumulated page views for a web page, where the number of page views is maintained by the analytics backend 302. For example, the user interface for viewing analytics information can be viewable in a browser. In this example, the user interface can be a web page accessible to a publisher for viewing aggregated statistical information. In other implementations, the communication sent at step 342 can include other information such as the geographic location of the request, duration of time spent viewing the page 112 or the number of unique visitors to the page 112.

In some implementations, the services available for a marker (e.g., markers 114 and 116) can be managed by one or more registrar systems 106, where the registrar system 106 can provide information needed to retrieve parameters for services using marker information. For example, a query to a registrar system 108 can include marker information. The identifiers for the markers can be used to lookup parameters for the services assigned to the markers.

In response to the query, the registrar system 106 can return the assignment of a marker to a service. In some implementations, this response can reduce the size of the response and thus reduce the bandwidth and network traffic involved. In some implementations, parameters can be included as part of the query. For example, a map service may include default length and width size parameters. Using this map example, the query can include length and width parameters to override the default parameters.

By way of further example, some services may not have their respective parameters managed by the registrar system 106. In this example, a second query may be sent to return the parameters. In some implementations, the second query can include marker information for markers with parameters not managed by the registrar system

In some implementations, queries made to the registrar system 106 can be formulated to limit the amount of responses that are sent to a browser 104. In some implementations, a service can be presented multiple times with a similar mapping of markers to services. As a result, the registrar 106 may store a default or common service for a publisher. For example, advertising may be a service commonly requested by a publisher for inclusion in a page. In this example, advertising can be stored by one or more server devices 108 as the default service for a publisher. In some examples, an advertising service can be configured as a default service without being the most commonly used service for a publisher. In such examples, if a marker does not include an assignment to a service, the configured default service can be used. In some examples, the default can be mentioned explicitly in the service information for fewer than all slots covered by the service information.

In some implementations, queries made to the registrar system 106 can be formulated to request the configuration for most or all of the markers in a page. For example, the page 112 can be a web page with markers 114 and 116 that are assigned advertising services. In this example, the query can avoid sending a response to the browser 104 as both markers 114 and 116 are presenting the default service, in this case advertising.

In some implementations, versions of assignments (e.g., the assignments 118, FIG. 1) can be temporarily stored and accessed. In some implementations, the version can be stored in a file. One example of a file commonly used for storing temporary information is a “cookie.” A cookie refers to text sent by a server (e.g., the server device 108) to a device (e.g., the device 102). Cookies can be used for authenticating, tracking and maintaining information. For example, the contents of a user's shopping cart while shopping for items on the internet can be stored in a cookie. In some implementations, one or more server devices 108 can manage configuration information related to the assignments 118. If the configuration information is updated, the one or more servers 108 can maintain a version, such as a numeric value, to be compared with the version stored in the cookie. For example, the numeric value can be incremented if the configuration information changes for a particular assignment 118. For instance, a change to one or more of the services assigned to a marker can trigger an update to the version number.

At the first visit to a page, the web browser 304 can communicate a request to one or more server devices 108 to retrieve the latest version of the configuration information for an assignment 118. In response, the one or more server devices 108 can send a script to create a cookie that includes the latest version of the assignment 118. For example, the latest version of an assignment mapping after the first visit to a page can be stored in a cookie as zero.

Following the above example, at the second visit to a page, the cookie includes a numeric value of zero. The browser 304 can communicate a request to one or more servers 108 that includes the version of the assignment 118 for the page being viewed. In some implementations, the version of the assignment that is maintained on the one or more server devices 108 can be unchanged since the last visit to the page. In some implementations, a response to update the version stored in the cookie is unnecessary if the version of the assignments match.

Following the above example further, at the third visit to a page, the one or more server devices 108 receives an update to the configuration for an assignment. The update has incremented the version for the assignment from zero to one. For example, the marker (e.g., the second marker 116) can be reconfigured from a previous service such as a map service to a video service. In this example, another one or more markers (e.g. the first marker 114) may be assigned a default service that is unchanged since the last visit to the page. In some implementations, a request to get the latest assignment versions can be sent at the end of a page as the page is interpreted by the browser 304. This request can update the cookie stored on the device 112.

Following the above example further, at the fourth visit to a page, the assignment 118 has a version of one stored on the one or more server devices 108 and a version of one in the cookie stored on the device 102. The browser 304 can communicate a request to one or more server devices 108 that includes the version number of one. In some implementations, the response can be retrieved from the cache (e.g., the browser cache 306). In some implementations, a response to update the version stored in the cookie is unnecessary if the version of the assignments match and updates have not been received by the one or more services 108 or cache.

In some implementations, the capability to store temporary information can be disabled. For example, web browsers such as those described earlier can include settings for enabling or disabling the storage of temporary information such as cookie files. In this example, the version information can be managed by the one or more servers 108 and can be refreshed at regular time intervals, such as once per day.

In some implementations, a publisher using the publisher system 104 can temporarily change the “normal” configuration for a marker/service pairing (e.g., the assignment 118). In some implementations, the publisher system 104 can include a user interface for overriding the normal configuration for assignments 118. In some implementations, the overriding can be accomplished by storing a temporary account identifier (e.g., the identifier 206) in a temporary cookie. The temporary account can be used to access the changed configurations, in some implementations, for experimental purposes. For example, a publisher can change the arrangement of services and markers on a page to achieve a better response to their content. In this example, the Google™ Website Optimizer can be used by an advertiser to experiment with advertising placement on a page 112.

In some implementations, services for a page can be assigned to a set of pages (page level) instead of for individual markers on the page. In some implementations, the page level services can be maintained as a configuration file stored on one or more server devices 108. For example, the analytics service 316 can be assigned to a group of pages, such as the pages in the “sports” area of a web site. In this example, an expiration time can be maintained. In some implementations, the last update time for a service associated with a marker can be stored along with the version information in a temporary storage cookie. If the version information changes, the last update time is stored in the cookie. If an unacceptable amount of time passes since the last update, a request can be sent to the one or more services 108 to retrieve the latest version for a service. This request can be made at the end of page to avoid affecting the view of the page.

In some implementations, the capability to temporarily store version information, for example using a cookie, can be disabled. If temporary version information storage is disabled, the <head> portion 202 of the code segment 200 can communicate a request to the one or more servers 108 each time the page 112 is presented. In some implementations, accessing the browser cache 104 to retrieve version information can be avoided. For example, the one or more servers 108 can respond to the page 112 with different service assignments 118 each time the page 112 is presented allowing a publisher to perform experiments regarding services assignments 118.

In some implementations, configuring placement separately for each of the markers (e.g., the markers 114 and 116) on a page (e.g., the page 112) by using a publisher system 104 can be avoided by storing the placement of the markers based on the URL of the page where the markers are presented with their respective services. Client-side storage refers, for example, to temporary storage available that is stored in ways other than a cookie file. For example, the HTML 5.0 specification includes client-side “sessionStorage” attributes. The sessionStorage is accessible to any page from the same web site opened in the page for that particular browser window. In some implementations, a combination of client-side storage and the registrar 106 can be used to manage the marker information based on the URL of the page presenting the markers.

The use of the registrar 106 and client-side storage to manage marker and service information can reduce the communications back and forth between a client and a server, such as the one or more server devices 108.

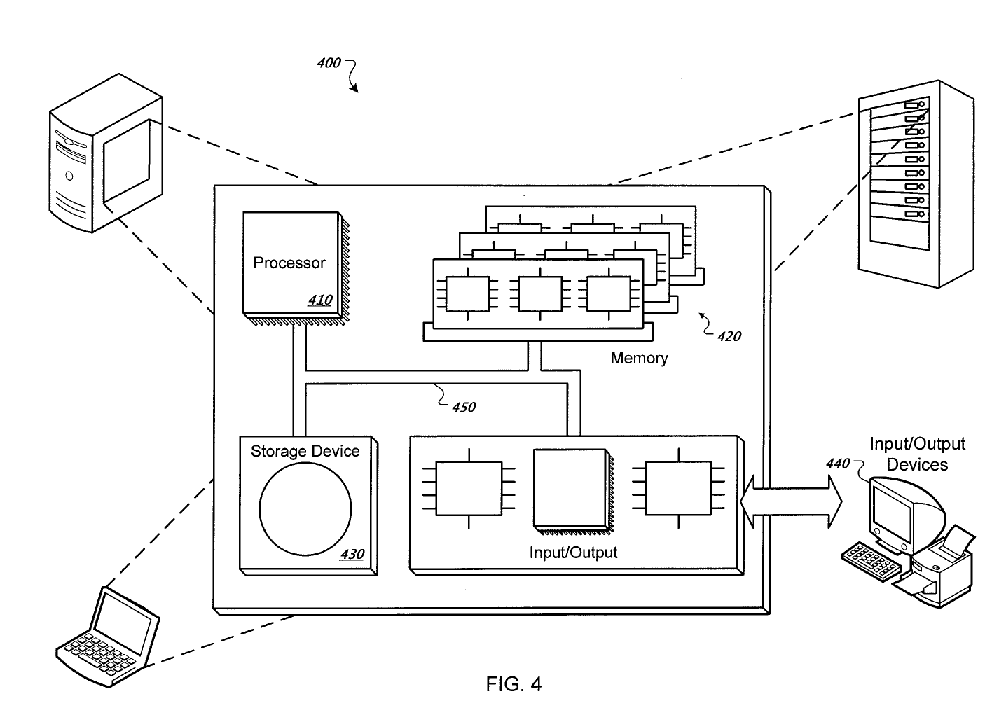

FIG. 4 is a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method for requesting a service, the method comprising:
accessing a universal tag included in media content on a first device, the universal tag configured for use in requesting content relating to any of a plurality of services for a portion of the media content;
receiving service information for the media content, the service information indicating at least a first service of the plurality of services as being assigned to the portion; and
generating a request for the first service identified by the service information, the request generated using the universal tag.

2. The computer-implemented method of claim 1, wherein the service information is received from a second device that includes a registrar system configured to communicate any of a plurality of portions of service information to a plurality of first devices, the registrar system configured for assigning the universal tag to another one of the plurality of services without modifying the media content.

3. The computer-implemented method of claim 1, wherein the media content includes a page and the plurality of services are page-level services, and wherein the universal tag is configured for use in requesting content for a plurality of slots on the page, and wherein the request is a single request applying to the plurality of slots.

4. The computer-implemented method of claim 3, wherein the page is generated by a publisher associated with an account identifier that is included in the universal tag, further comprising:
registering information about which of the plurality of services the publisher uses; and
using the information in at least one of generating the request and responding to the request.

5. The computer-implemented method of claim 3, wherein the first service includes serving an advertisement to the page, and wherein the universal tag in addition is configured to request content for the page from a second service, the method further comprising:
receiving version information with the advertisement, the version information indicating that the second service has been updated to a new version; and
generating a request for updated service information, the request indicating that the updated service information is to cover the new version.

6. The computer-implemented method of claim 3, wherein at least the first service is requested using a script portion, the method further comprising:
receiving the script portion from a third device in connection with requesting the page; and
storing the script portion in a memory on the first device;
wherein when the page is generated the script portion is obtained from one of the third device and the memory depending on whether the script portion has previously been stored.

7. The computer-implemented method of claim 3, wherein the first service is defined as a default service among the plurality of services, and wherein the service information:
indicates that the first service is assigned to the portion by not explicitly mentioning the first service; and
for any other slot on the page assigned to a second service that is not the default service, indicates the assignment to the second service by explicitly mentioning the second service.

8. The computer-implemented method of claim 7, further comprising:
detecting that a publisher of the page uses the first service most frequently; and
assigning the first service to be the default service based on the detection.

9. The computer-implemented method of claim 1, further comprising:
generating a request for the service information, wherein the service information when received further identifies at least one parameter to be used in the first service; and
using the parameter in requesting the first service.

10. The computer-implemented method of claim 1, further comprising:
changing the assignment of the first service to the universal tag without modifying the media content.

11. The computer-implemented method of claim 10, wherein changing the assignment comprises:
removing the assignment of the first service and instead assigning a second service to the universal tag, the second service provided from a third device, wherein the assignment of the second service does not involve a modification at the third device.

12. The computer-implemented method of claim 1, further comprising:
receiving identification of at least one parameter with the service information;
generating script for requesting the first service; and
using the script in generating the request for the first service.

13. The computer-implemented method of claim 1, wherein a parameter is not delivered with the service information, the method further comprising:
deriving at least one parameter based on a marker associated with the universal tag.

14. The computer-implemented method of claim 1, wherein the service information is subject to versioning based on service enhancements, the method further comprising:
in connection with a first time the media content is provided to the first device, storing on the first device a first version number regarding the assignment of the first service to the universal tag;
forwarding the first version number when another request is generated; and
using the stored first version number in requesting the service information, until an instruction is received, in response to forwarding the first version number, that the first version number has been updated to a second version number.

15. The computer-implemented method of claim 1, wherein the service information further indicates a second service of the plurality of services as being assigned to another portion of the media content, the method further comprising:
receiving additional service information having a higher priority than the service information, the additional service information indicating that the second service is not to be requested for the other portion;
wherein the second service is not requested for the other portion based on receiving the additional service information.

16. The computer-implemented method of claim 1, wherein the media content includes a page, at least some of the plurality of services are page-level services, and the service information is subject to versioning based on service enhancements, the method further comprising:
storing at the first device a current version number of the assignment of the first service to the portion of the page, and a last update time of the assignment;
updating the last update time based on the assignment being modified;
using the current version number if the last update time does not meet an expiration criterion; and
requesting a new version number if the last update time meets an expiration criterion.

17. The computer-implemented method of claim 1, further comprising:
determining a number of portions of the media content, including the portion assigned to the first service, that are assigned to any of the plurality of services;
comparing the determined number with the service information, which is stored in a non-cookie storage on the first device; and
updating the service information if the comparison shows that the service information does not match the determined number.

18. A system comprising:
a first device accessible to a user, the first device configured to access a universal tag included in media content and configured for use in requesting content relating to any of a plurality of services for a portion of the media content;
a registrar system configured to provide service information for the media content to the first vice, the service information indicating at least a first service of the plurality of services as being assigned to the portion; and
a server device configured to provide the first service to the first device in response to a request generated using the universal tag.

19. The system of claim 18, wherein the media content includes a page having a plurality of slots, and wherein the first service includes providing an advertisement for the page.

20. The computer program product of claim 18, wherein the first device is configured to store script for requesting the content in a memory on the first device, and wherein the first device obtains the scrip using the universal tag and generates the request using the script.

21. A computer-implemented method for requesting a service, the method comprising:
accessing a tag included in media content on a first device, the tag configured for use in calling a service description for each of at least two portions of the media content;
receiving the service description for the media content, the service description indicating at least a first service of the plurality of services as being assigned to the portion; and
generating a request for the first service identified by the service description, the request generated using the tag.

22. A computer-implemented method for indicating a service, the method comprising:
receiving an identifier associated with first media content, the identifier obtained from a tag included in the first media content, the tag configured for use in requesting second media content relating to any of a plurality of services;
accessing an assignment record using the identifier, the assignment record including assignments relating to the plurality of services; and
forwarding service information for the first media content, the service information indicating at least a first service of the plurality of services to be used in obtaining the second media content.

23. The computer-implemented method of claim 22, wherein the first media content is a page to be displayed on a computer device, and wherein the service information is provided from a registrar system configured to provide indications regarding the plurality of services to a plurality of pages.

24. The computer-implemented method of claim 23, wherein the first service is defined as a default service among the plurality of services, and wherein the service information:
indicates that the first service is to be used in obtaining the second media content by not explicitly mentioning the first service; and
for any other slot on the page assigned to a second service that is not the default service, indicates the assignment to the second service by explicitly mentioning the second service.
